(19) United States
(12) Patent Application Publication
(10) Pub. No.: US 2011/0083569 A1
(43) Pub. Date: Apr. 14, 2011

(54) Stamp

(76) Inventor: Chang-Yi Lin, Fongyuan City (TW)

(21) Appl. No.: 12/588,312

(22) Filed: Oct. 13, 2009

(51) Int. Cl. B41K 1/42

(52) U.S. Cl. 101/333

(57) ABSTRACT

A stamp comprises a body including a receiving room disposed on a lower end thereof and having a through hole on an upper end of the receiving room; a stamping member including at least one column, each inserted to the through hole of the body, and including a stamp member having at least one guiding member; at least one resilient element, an upper end of which abuts against the stamping assembly and a lower end thereof is biased against the body; a housing located under the body and having at least one connecting portion coupled with the stamping assembly so as to actuate with the stamping assembly each other; at least one lip including a slot and two pegs disposed on two sides thereof respectively, and including a hook on at lease one side.

### BACKGROUND OF THE INVENTION

1. Field of the Invention

The present invention relates to a stamp that is capable of turning and opening the lips smoothly, protecting a stamping surface.

2. Description of the Prior Art

Conventional stamp does not include any lip to prevent the inks from dipping user, and can not be stamped continuously.

The present invention has arisen to mitigate and/or obviate the afore-described disadvantages.

### SUMMARY OF THE INVENTION

The primary object of the present invention is to provide a stamp which is capable of turning and opening the lips smoothly, protecting a stamping surface.

Another object of the present invention is to provide a stamp which increases stamping area and prolongs service of the stamp.

To achieve the above object, a stamp provided by the present invention comprises:

a body including a receiving room disposed on a lower end thereof and having a through hole on an upper end of the receiving room;

a stamping member including at least one column, each inserted to the through hole of the body, and including a stamp member having at least one guiding member;

at least one resilient element, an upper end of which abuts against the stamping assembly and a lower end thereof is biased against the body;

a housing located above the body and having at least one connecting portion coupled with the stamping assembly so as to actuate with the stamping assembly each other;

at least one lip including a slot and two pegs disposed on two sides thereof respectively, and including a hook on at lease one side.

### BRIEF DESCRIPTION OF THE DRAWINGS

FIG. 1 is a perspective view illustrating the exploded components of a stamp in accordance with a first embodiment of the present invention;

FIG. 2 is a cross sectional view illustrating the assembly of the stamp in accordance with the first embodiment of the present invention;

FIG. 3 is another cross sectional view illustrating the assembly of the stamp in accordance with the first embodiment of the present invention;

FIG. 4 is a cross sectional view illustrating the operation of the stamp in accordance with the first embodiment of the present invention;

FIG. 5 is a cross sectional view illustrating the assembly of a stamp in accordance with a second embodiment of the present invention;

FIG. 6 is a cross sectional view illustrating the assembly of a stamp in accordance with a third embodiment of the present invention;

FIG. 7 is a cross sectional view illustrating the assembly of a stamp in accordance with a fourth embodiment of the present invention;

FIG. 8 is a top plan view illustrating the assembly of the stamp in accordance with the fourth embodiment of the present invention;

FIG. 9 is a plan view illustrating the assembly of a body of a stamp in accordance with a fifth embodiment of the present invention;

FIG. 10 is a plan view illustrating the assembly of a stamp in accordance with a sixth embodiment of the present invention;

FIG. 11-1 is a plan view illustrating a positioning button being disposed on a housing in accordance with a seventh embodiment of the present invention;

FIG. 11-2 is a plan view illustrating a positioning button being disposed on a body in accordance with the seventh embodiment of the present invention;

FIG. 12-1 is a cross sectional view illustrating a tube and a fount of a stamp in accordance with an eighth embodiment of the present invention;

FIG. 12-2 is a top plan view illustrating a frame of the stamp in accordance with the eighth embodiment of the present invention;

FIG. 12-3 is a cross sectional view illustrating the frame of the stamp in accordance with the eighth embodiment of the present invention;

FIG. 13-1 is a top plan view illustrating a stamping assembly of the stamp in accordance with a ninth embodiment of the present invention;

FIG. 13-2 is a cross sectional view illustrating the stamping assembly of the stamp in accordance with the ninth embodiment of the present invention;

FIG. 13-3 is another cross sectional view illustrating the stamping assembly of the stamp in accordance with the ninth embodiment of the present invention;

FIG. 13-4 is a top plan view illustrating a square frame of the stamp in accordance with the ninth embodiment of the present invention;

FIG. 13-5 is a cross sectional view illustrating a square frame of the stamp in accordance with the ninth embodiment of the present invention;

FIG. 13-6 is another cross sectional view illustrating the square frame of the stamp in accordance with the ninth embodiment of the present invention;

FIG. 14 is a cross sectional view illustrating the assembly of a stamp in accordance with a tenth embodiment of the present invention;

FIG. 15-1 is a plan view illustrating the operation of two lips of a stamp in accordance with an eleventh embodiment of the present invention;

FIG. 15-2 is another plan view illustrating the operation of the two lips of the stamp in accordance with the eleventh embodiment of the present invention;

FIG. 15-3 is a bottom plan view illustrating the operation of the two lips of the stamp in accordance with the eleventh embodiment of the present invention;

FIG. 15-4 is another bottom plan view illustrating the operation of the two lips of the stamp in accordance with the eleventh embodiment of the present invention;

FIG. 15-5 is also another bottom plan view illustrating the operation of the two lips of the stamp in accordance with the eleventh embodiment of the present invention;

FIG. 16 is a perspective view illustrating the assembly of a stamp in accordance with a twelveth embodiment of the present invention;

FIG. 17 is a top plan view illustrating the assembly of a stamp in accordance with a thirteen embodiment of the present invention;

FIG. 18 is a cross sectional view illustrating the operation of the stamp in accordance with the thirteen embodiment of the present invention;

FIG. 19-1 is a plan view illustrating an adjusting knob of the stamp in accordance with the thirteen embodiment of the present invention;

FIG. 19-2 is a cross sectional view illustrating the adjusting knob of the stamp in accordance with the thirteen embodiment of the present invention;

FIG. 20 is a cross sectional view illustrating the operation of a projection of the stamp in accordance with the thirteen embodiment of the present invention;

FIG. 21 is another cross sectional view illustrating the operation of the projection of the stamp in accordance with the thirteen embodiment of the present invention;

FIG. 22 is also another cross sectional view illustrating the operation of the projection of the stamp in accordance with the thirteen embodiment of the present invention;

FIG. 23 is a top plan view illustrating a body of the stamp in accordance with the thirteen embodiment of the present invention;

FIG. 24-1 is a plan view illustrating an adjusting knob of a stamp in accordance with a fourteen embodiment of the present invention;

FIG. 24-2 is a cross sectional view illustrating the adjusting knob of the stamp in accordance with the fourteen embodiment of the present invention;

FIG. 24-3 is another cross sectional view illustrating the adjusting knob of the stamp in accordance with the fourteen embodiment of the present invention;

FIG. 25 is a plan view illustrating a housing of a stamp in accordance with a fifteen embodiment of the present invention;

FIG. 26 is a cross sectional view illustrating the housing of the stamp in accordance with the fifteen embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

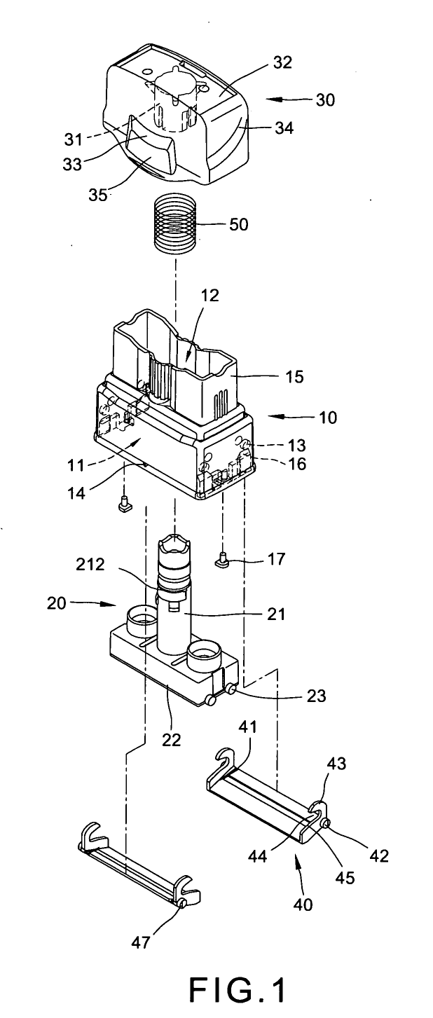

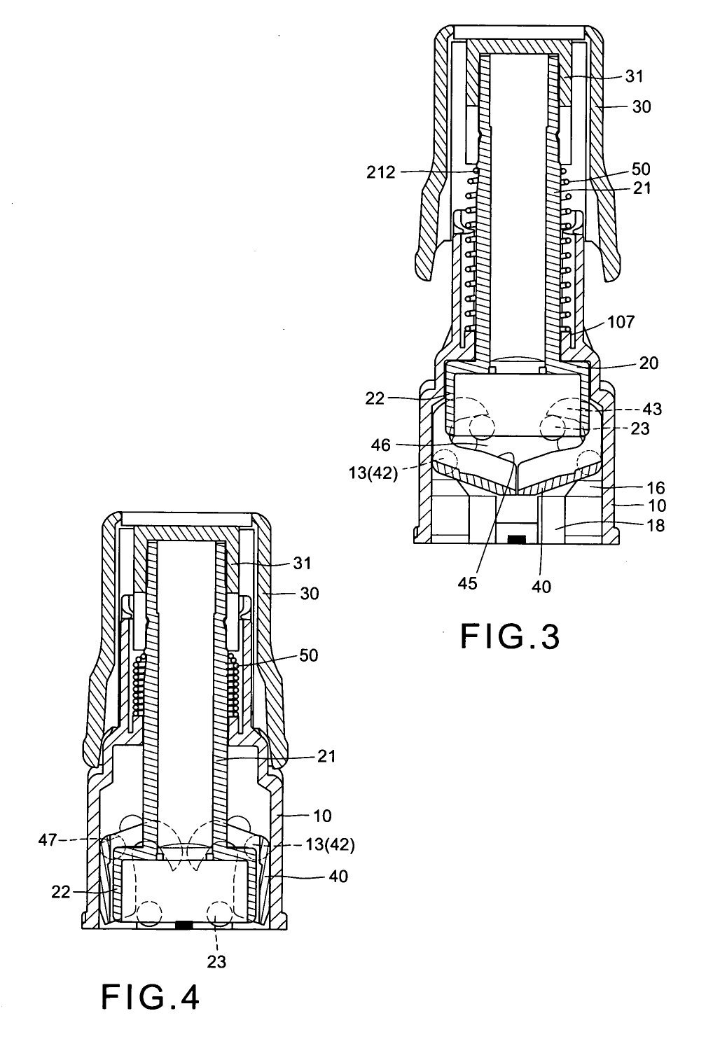

Referring to FIGS. 1-4, a stamp in accordance with the present invention comprises a body 10, a stamping assembly 20, a housing 30, two lips 40, and a resilient element 50, wherein the body 10 includes a receiving room 11 disposed on a lower end thereof and having a through hole 12 on an upper end of the receiving room 11 and having two axial bores 13 mounted on two side walls of the receiving room 11, each axial bore 13 is provided to receive a peg 42 of the lip 40 to reduce friction (conventional axial bore is formed in a concaved arc shape, therefore the peg 42 rubs against the axial bore), thus prolonging service life of the stamp. The inner wall of the axial bore 13 is designed in a piece shape so as to obtain flexibly and to expand outward as being pressed to assemble to the lip 40, the body 10 includes a protective wall 15 arranged around an upper portion thereof, and includes a plurality of inclined planes 16 fixed on two inner walls thereof and two anti-slip blocks 17 secured at predetermined positions thereof, the anti-slip block 17 is made of a rubber material to prevent the body 10 from slipping as stamping the stamp, and the body 10 further includes a marking point 14 to make an aligning signal, preventing the stamp from stamping unclearly.

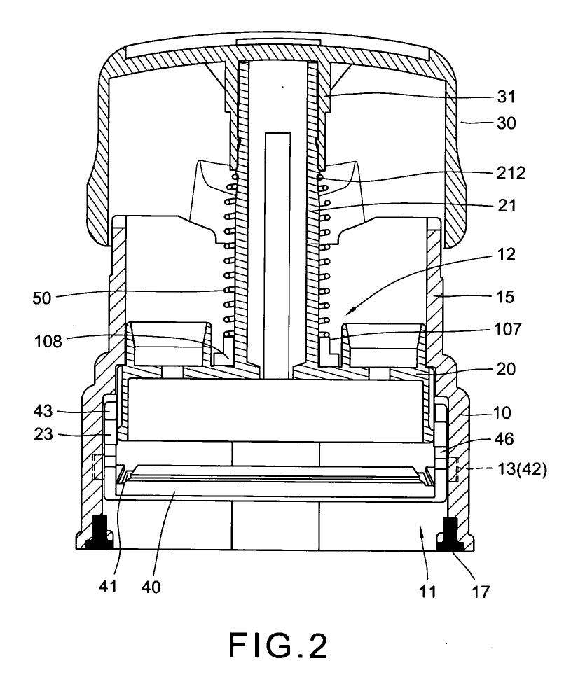

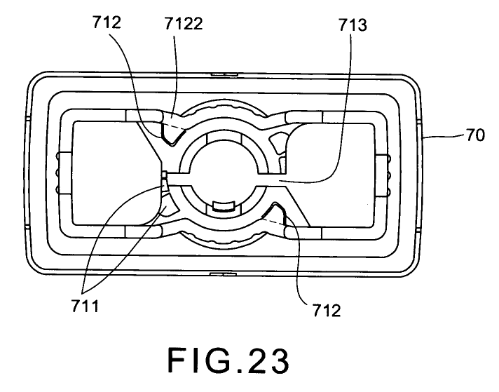

The stamping member 20 includes a plurality of columns 21, each inserted to the through hole 12 of the body 10, and includes a stamp member 22, wherein at least one column 21 (e.g., a middle column) includes a dent 212 to fit the resilient element 50 thereon so that an upper end of the resilient element 50 abuts against the dent 212 and a lower end thereof is biased against the body 10, such that the stamping assembly 20 returns to its original position, hence between the stamping assembly 20 and the through hole 12 is defined a gap 108 (as shown in FIG. 2) to be an expending space as the column 21 passes across (e.g., an expanding space 713 as illustrated in FIG. 23) the gap 108, and an edge 107 of the through hole 12 abuts against the column 21. The stamp member 22 includes two guiding blocks 23 disposed on two sides thereof, and at lease one of the body 10 or the lip 40 includes at least one retracting space 41 mounted on a periphery thereof.

The housing 30 is fixed on an upper side of the body 10 and includes at least one connecting portion 31 formed therein to connect with a middle column 21 of the stamping assembly 20 so that the housing 30 actuates the stamping assembly 20, the housing 30 includes a recess 32 arranged on a top surface thereof to couple with a transparent covering to receive content of the stamp, and advertisement, etc (the recess 32 extends to front and back sides of the housing 30 or left and right sides thereof), the lip 40 includes two pegs 42 fixed on two sides thereof respectively, and includes a hook 43 disposed on at least one side thereof and having a slot 44 with a sliding surface 45 disposed on an inner side of the lip 40, such that the inclined planes 16 of the body 10, at least one side of the lip 40, and the hook 43 abut against an inner wall of the body 10, and the peg 42 of the lip 40 includes a chamfer 47 formed thereon to facilitate assembly.

The housing 30 includes two abutting segment 33 (34) disposed on at least one plane thereof, wherein the abutting segment 33 of front and back planes of the housing 30 includes a thickness face 35 on a lower side of the housing 30, and the thickness of the thick face 35 increases a suitable height from downward to upward, and the abutting segments 34 are fixed on left and right planes of the housing 30 individually, the body 10 also includes a piece-shaped anti-slip member.

In assembly, the pegs 42 of the lip 40 are slid through the inclined planes 16 and the lips 40 are shorten by using the retracting space 41 so that the pegs 42 of the lip 40 are inserted to the axial bores 13, and the lips 40 are fixed in the receiving room 11. Thereafter, between the guiding members 23 of the stamp member 22 and the sliding surfaces 45 of the slot 44 is defined a non-resist chamber 46 in the slot 44, when the stamping assembly 20 is actuated downward and the guiding members 23 contact with the sliding surfaces 45 via the non-resist chambers 46, the lips 40 are lightly turned with the stamping assembly 20 to stamp smoothly. In addition, the lips 40 contact with the stamping assembly 20 tightly to prevent ink from evaporation. Because the stamping assembly 20 does not include a strap disposed on an inner wall thereof, a stamping area of the stamp member 22 is increased.

In operation, the housing 30 is pressed to actuate the stamping assembly 20 to move downward, so that the guiding members 23 of the stamping assembly 20 drive the sliding surfaces 45 of the lips 40 via the non-resist chambers 46 to rotate the lips 40 along the pegs 42, therefore the two lips 40 are tuned open so as to stamp the stamp member 22; when the housing 30 is released, the stamp member 22 is pushed to return its original position by the resilient element 50, and the guiding members 23 of the stamp assembly 20 are driven to rotate the hooks 43 of the lips 40 in opposite position, so that the two lips 40 are turned to close the stamp member 22, hence the lips 40 are turned smoothly with the stamp assembly 20, and since at least one sides of the lips 40 abut against the inner wall of the body 10 tightly, lowering evaporating speed of the ink.

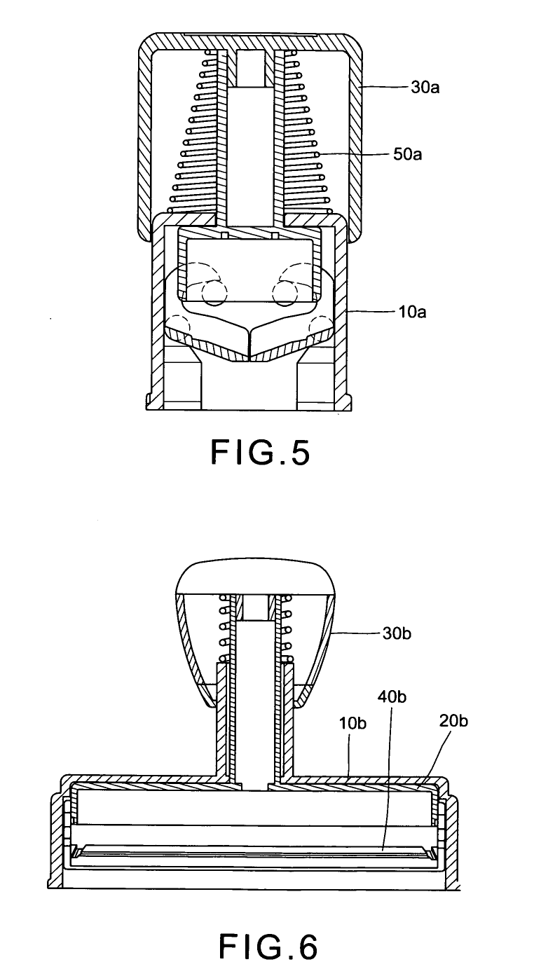

Referring to FIG. 5, a housing 30s and a body 10a are formed in another shape different from the first embodiment of the present invention, and a resilient element 50a is formed in a cone shape.

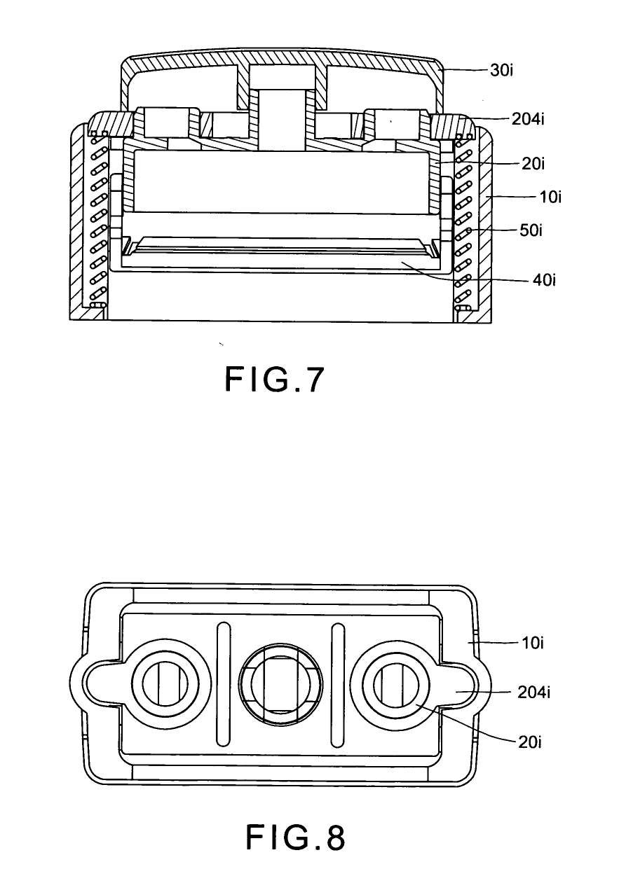

As shown in FIG. 6, a housing 30b is formed in a handle shape, and the stamp includes a body 10b, a stamping assembly 30b, and two lips 40b. With reference to FIGS. 7 and 8, a housing 30i and a body 10i are made in a small size, and a stamping assembly 20i is made in a small size, and includes an protrusion 204i to be pressed by a resilient element 50i, and includes two lips 40i, thereby packing and be portable easily.

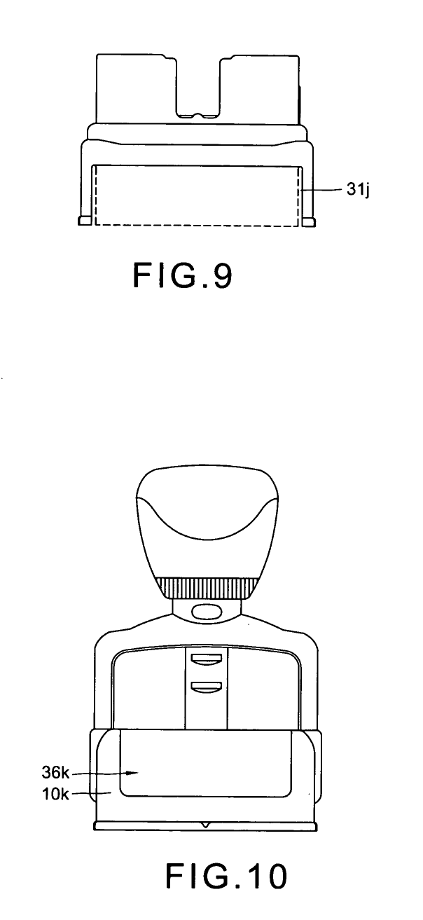

As illustrated in FIG. 9, a retracting space 31j is disposed on the inner wall of the body so that two retracting space 31j are connected together to form a denting side, e.g., the body includes at least one notch on the inner wall of top and bottom planes thereof so as to fit a transparent casing to see a predetermined stamping position and to lower size of the stamp; a recess 36k is formed in a predetermined shape identical to that of FIG. 10 and fixed in a body 10k, thereby having the same function as the recess 32.

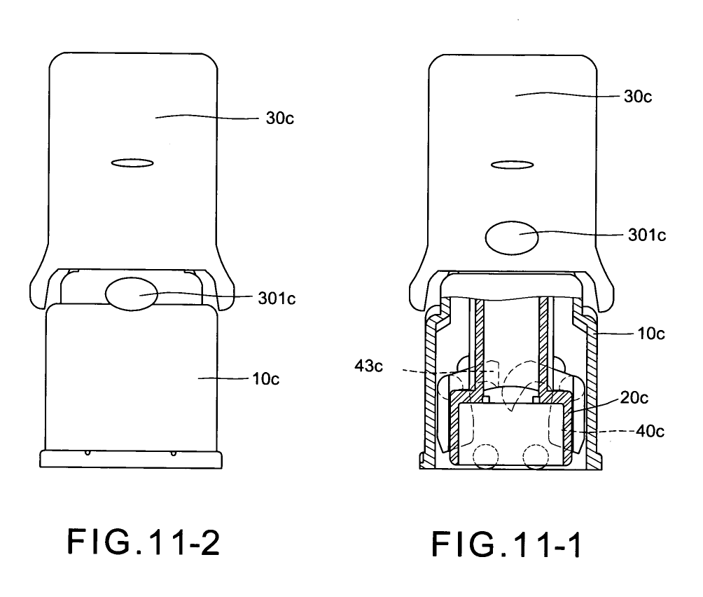

As illustrated in FIG. 11-1, two hooks 43c of each lip 40c are not symmetrical so that the lips 40c are turned to prevent hooks 43c from contacting with each other. The housing 30c includes at least one positioning button 301c (as shown in FIG. 11-1) to be pushed to lock the body 10c. As illustrated in FIG. 11-2, the positioning button 301c is mounted on the body 10c so as to be pushed to lock the stamping assembly 20c, preventing the stamping assembly 20c from extending outward.

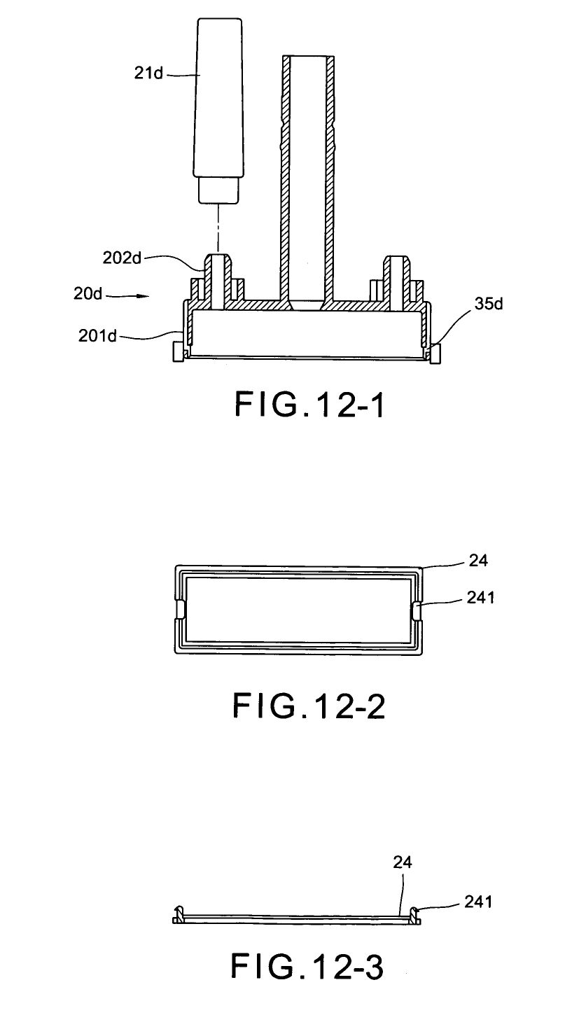

With reference to FIGS. 12-1, 12-2, and 12-3, a stamping assembly 20d includes at least one tube 202d to retain a fount 21d, an upper end of the tube 202d is formed in an arc shape to retain the fount 21d, and includes a frame 24 disposed under the stamping assembly 20d to protect and support a sealing member 201d, and includes two fastening extensions 241 mounted on two sides thereof respectively to hook an aperture 35d of the sealing member 201d, and a shape of the frame 24 is change based on that of the sealing member 201d.

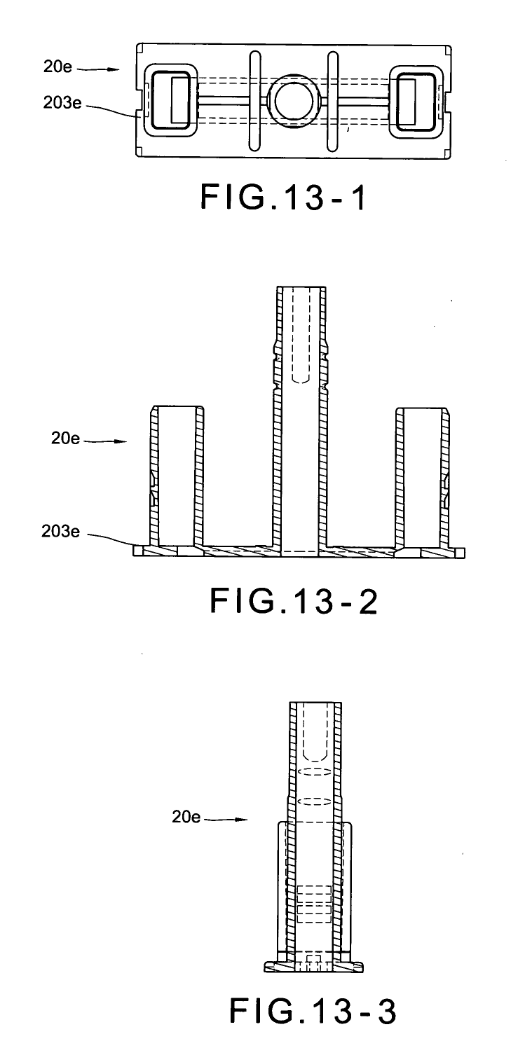

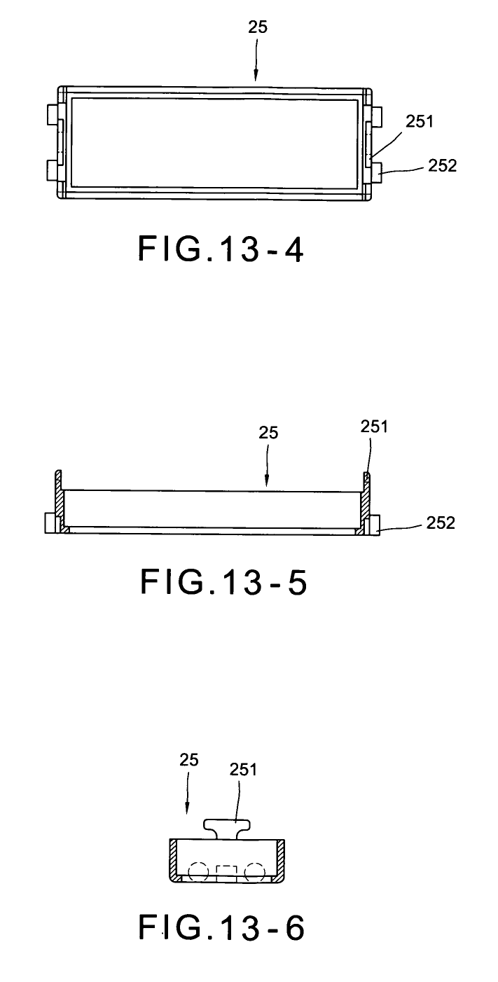

In another assembly, as shown in FIGS. 13-1, 13-2, 13-3, 13-4, 13-5, and 13-6, the stamping assembly 20e includes a square member 25 having a locking periphery 251 to retain a fringe 203e of a stamping assembly 20e to become one part of the stamping assembly 20e, and a square member 25 includes two guiding members 252 fixed on two sides thereof.

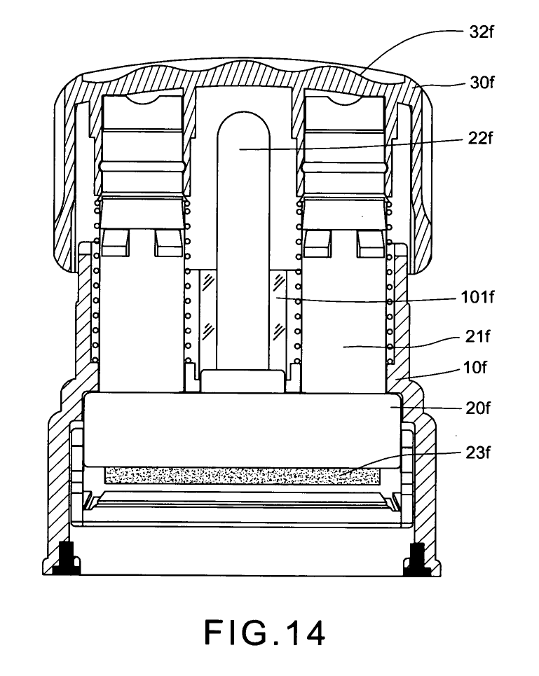

As illustrated in FIG. 14, a housing 30f is coupled on a column 21f of a stamping assembly 20f and includes a wave-shaped recess 32f to increase area of the recess 32f so as to receive a larger size of paper, one of a body 10f and a stamping assembly 20f includes a transparent container 22f to receive inks, and the body 10f includes a transparent member 101f disposed on at least one plane of the body 10f so that a user can see the remaining content of the transparent container 22f to fill inks or replace the transparent container 22f.

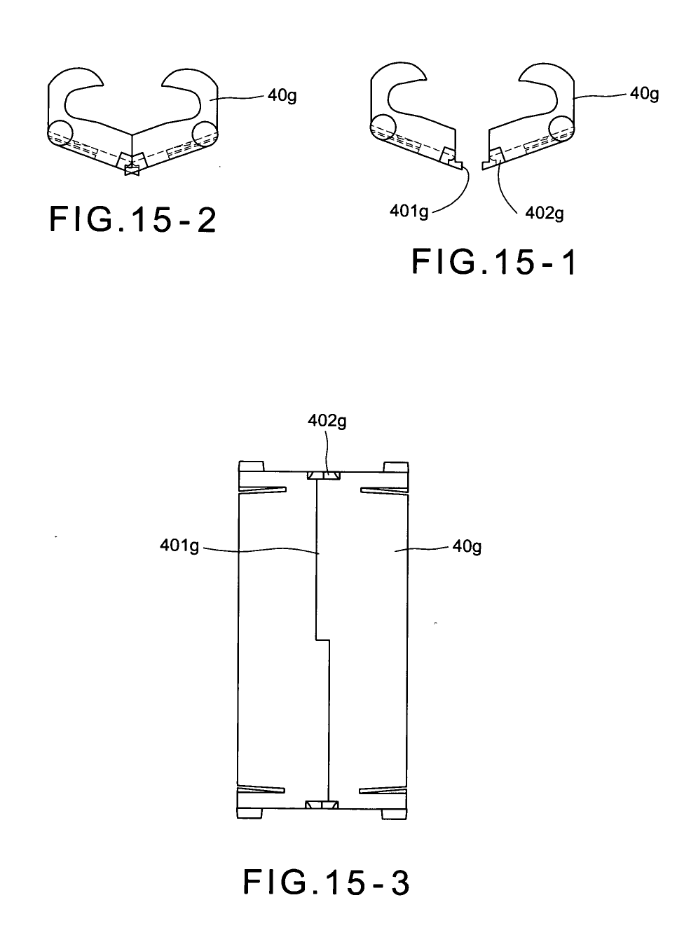

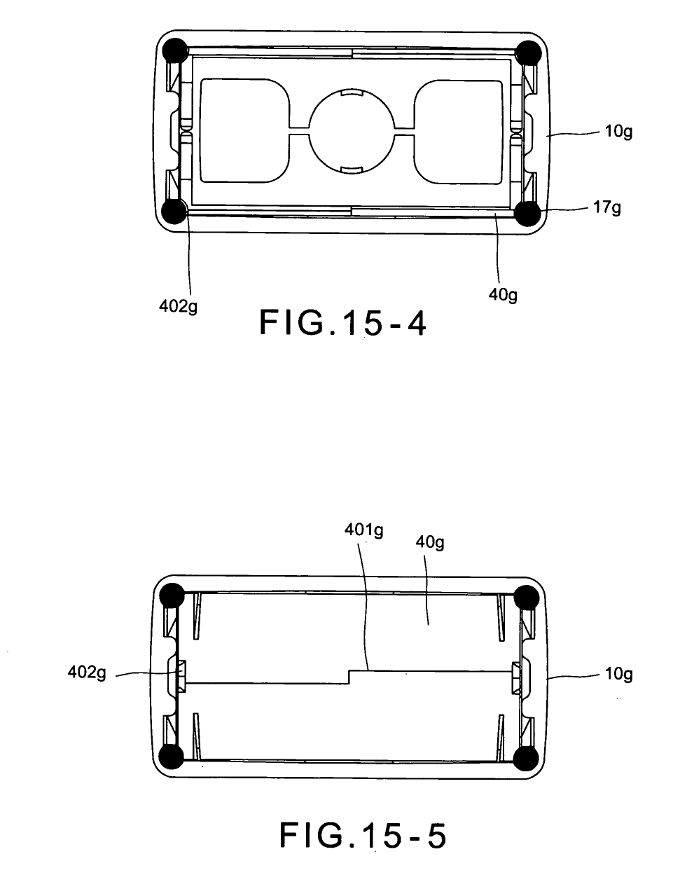

With reference to FIGS. 15-1, 15-2, 15-3, 15-4, and 15-5, on an adhering portion 401g of two lips 40g are designed in a concave and convex manner to close tightly, a body 10g includes four anti-slip blocks 17g disposed on a lower side thereof, and the adhering portion 401g includes two cuts 402g mounted on two sides thereof so that as the lips 40g are open, the anti-slip blocks 17 and a cut 402 are at the same position but not contact with each other, thus expending smoothly.

As illustrated in FIG. 16, a lip 30h includes a tilted recess 32h having a transparent casing to receive label or patterns so that user allows to distinguish the label or the patterns clearly.

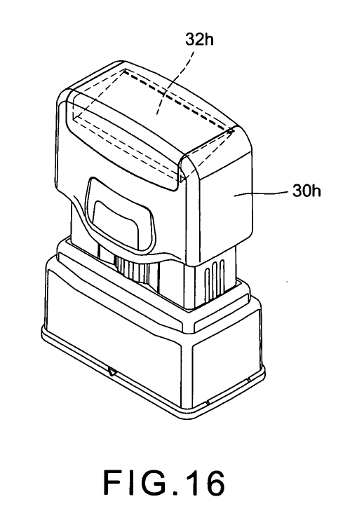

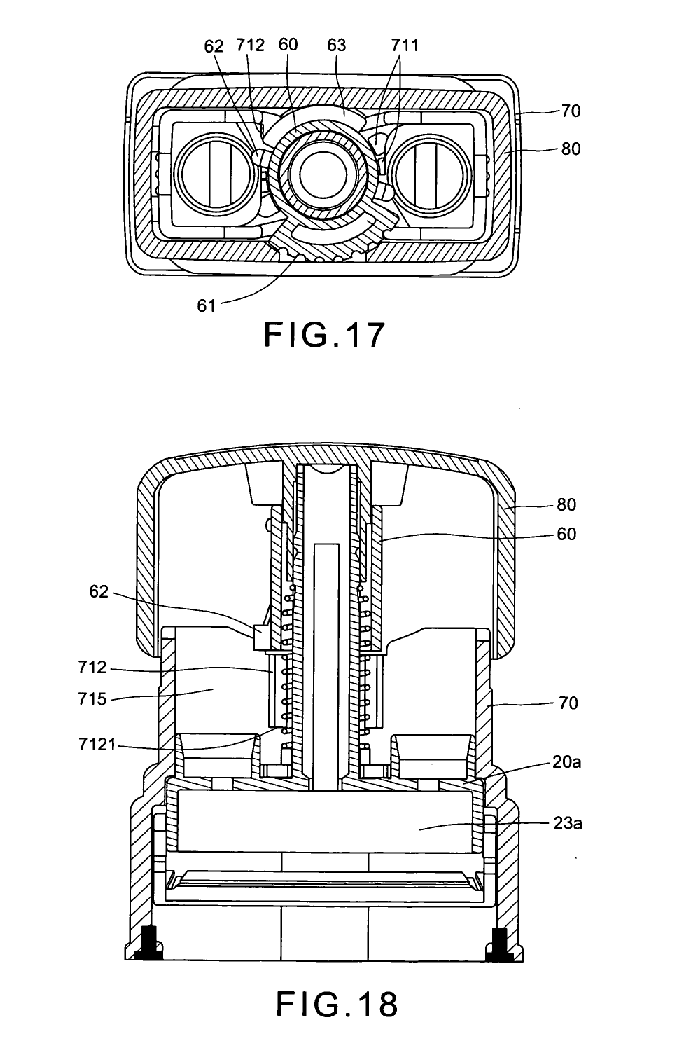

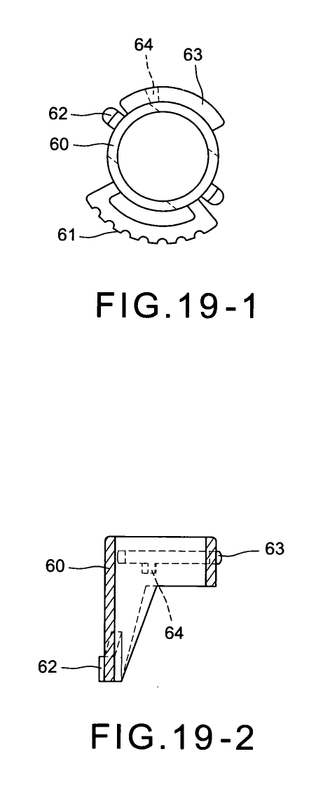

With reference to FIGS. 17, 18, 19-1, and 19-2, an adjusting knob 60 is received between a body 70 and a lip 80 and moves upward and downward with the lip 80, the adjusting knob 60 includes a contact surface on a front plane thereof, and two projections 62 on relative portions of a bottom end thereof, and a step 711 (abutting surface) arranged at different height on the bottom end thereof to match with the body 70 to control a stamping surface to extend outward. As shown in FIGS. 17 and 18, when the adjusting knob 60 is rotated to an angle, the projections 62 shrink a protective wall 715 and a rib 712 to move the lip 80 upward and downward freely.

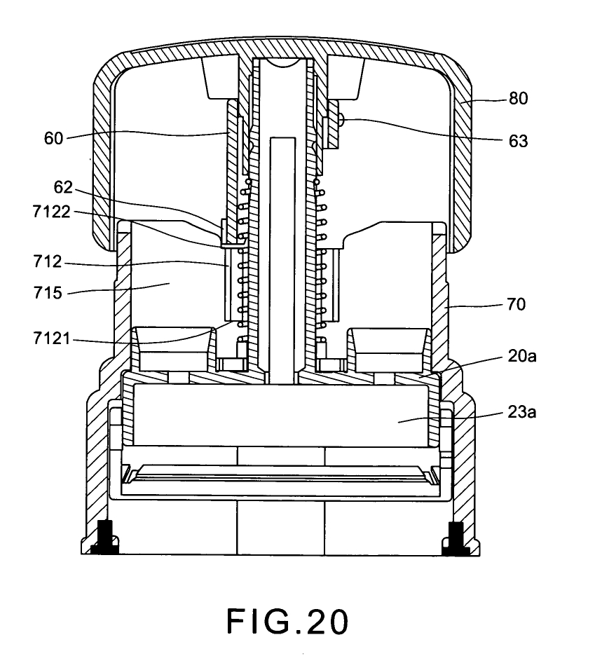

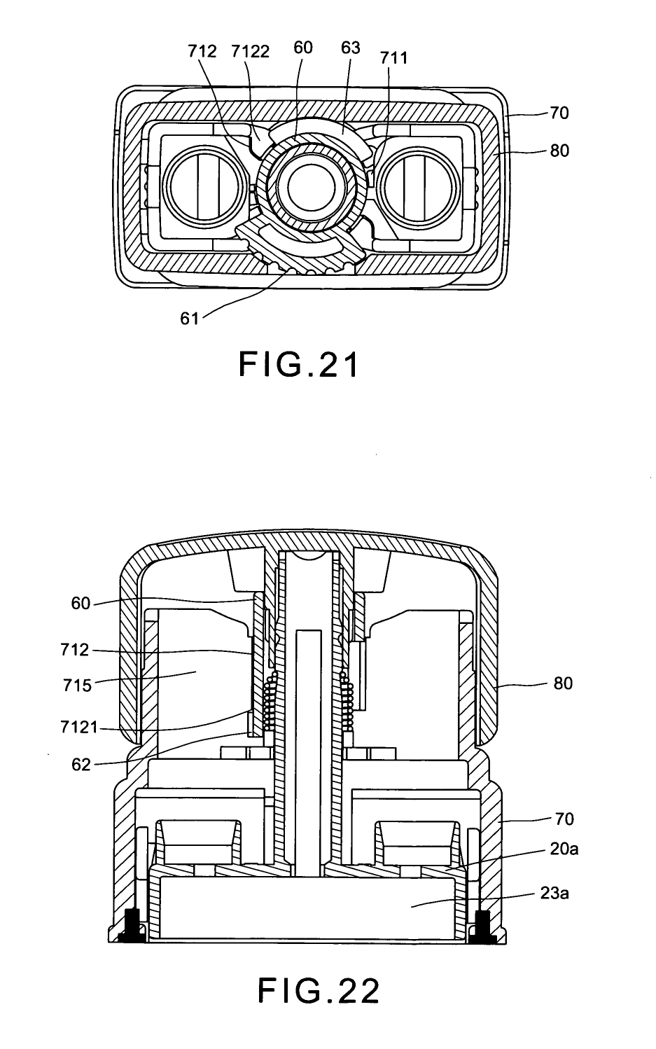

Referring to FIG. 20, if the adjusting knob 60 is further rotated to an angle, the projections 62 are fitted to the protective wall 715 of the body 70 and can not move the lip 80. As illustrated in FIGS. 21, 22, when the lip 80 is pressed, the rib 712 includes a stopping rim 7121 secured on a lower end thereof, as the lip 80 is pressed to rotate the adjusting knob 60 to an angle, the projections 62 are biased against the stopping rim 7121 of the body 70 so that the lip 80 can not be moved upward and downward to extend the sealing member, replacing the content of the sealing member easily. Besides, the adjusting knob 60 is used to position the lip 80 and the stamping assembly 80 at a predetermined position. Therefore, the projections 62 of the adjusting knob 60 are fixed between the body 70 and the lip 80 to extend the stamp member 23a at a predetermined position, and because the projections 62 are arranged around the adjusting knob 60, thus obtaining a balanced locking purpose. As shown in FIG. 23, a through hole of the body 70 includes a gap 713 disposed therein to insert a column.

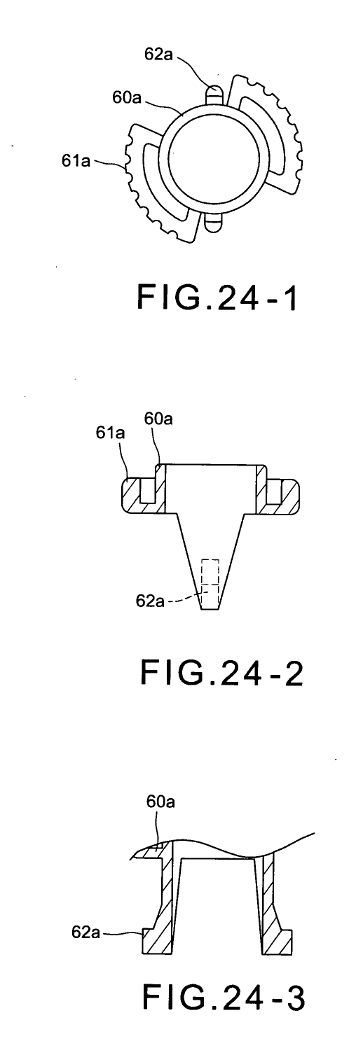

With reference to FIGS. 24-1, 24-2, and 24-3, the adjusting knob 60a is placed between the body 70 and the lip 80, and includes two contact planes 61a on front and back planes thereof respectively, and includes two projections 62a fixed on a bottom end thereof to control the sealing surface to extend outward.

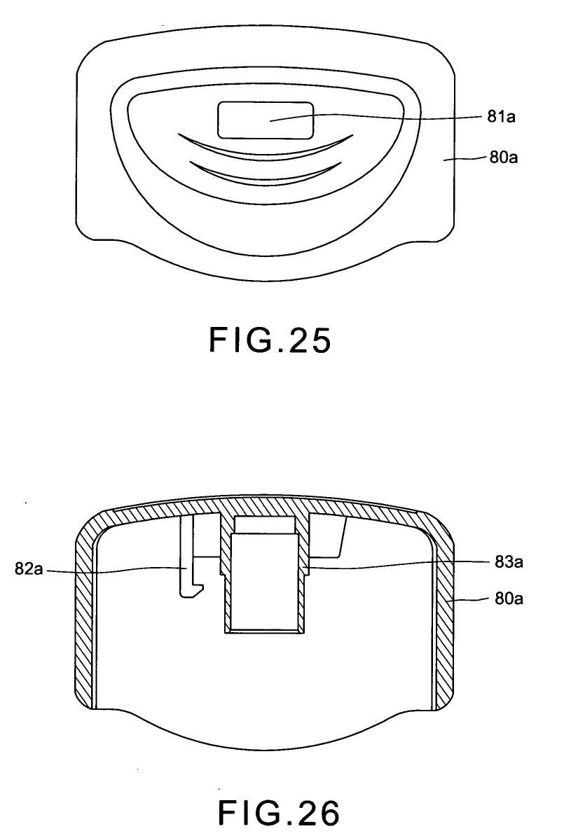

The stamp of the present invention is held by one hand to control the adjusting knob 60 (60a), thereby controlling the stamp easily. Referring to FIG. 25, a lip 80a includes an opening 81a which allows to change its position with the adjusting knob 60 (60a) and to extend the contact surfaces 61 (61a) outward to be pushed by a thumb. As shown in FIGS. 19-1, 19-2, and 26, the adjusting knob 60 includes an arcuate member 63 fixed on another side thereof and a raised bar 64 attached on a bottom side thereof, and the lip 80a includes a pillar 82a and a connecting portion 83a so that the arcuate member 63 is located between the pillar 82a and the coupling 83a, and the raised bar 64 stops the pillar 82a to limit the adjusting knob 60 to rotate.

While we have shown and described various embodiments in accordance with the present invention, it is clear to those skilled in the art that further embodiments may be made without departing from the scope of the present invention.

What is claimed is:

1. A stamp comprising:
a body including a receiving room disposed on a lower end thereof and having a through hole on an upper end of the receiving room;
a stamping member including at least one column, each inserted to the through hole of the body, and including a stamp member having at least one guiding member;
at least one resilient element, an upper end of which abuts against the stamping assembly and a lower end thereof is biased against the body;
a housing located above the body and having at least one connecting portion coupled with the stamping assembly so as to actuate with the stamping assembly each other;
at least one lip including a slot and two pegs disposed on two sides thereof respectively, and including a hook on at lease one side.

2. The stamp as claimed in claim 1, wherein the lip includes an expanding space to position the lip in the receiving room of the body.

3. The stamp as claimed in claim 1, wherein a screw extends from a bottom end of the knob and is screwed with a nut to be fixed on the support assembly.

4. The stamp as claimed in claim 1, wherein the body includes at least one inclined plane disposed on an inner wall thereof to retain the peg of the lip to the body via the inclined plane.

5. The stamp as claimed in claim 1, wherein the stamping assembly includes at least one tube to fit a fount therein.

6. The stamp as claimed in claim 1, wherein between the stamping assembly and the through hole is defined a gap.

7. The stamp as claimed in claim 1, wherein the housing includes at least one positioning button to lock the body.

8. The stamp as claimed in claim 1, wherein an adhering portion between the lips includes two cuts mounted on two sides thereof respectively.

9. The stamp as claimed in claim 1, wherein the housing includes a tilted recess.

10. The stamp as claimed in claim 1, wherein the housing includes a wave-shaped recess to increase area of the recess.

11. The stamp as claimed in claim 1, wherein the body includes a transparent container to receive inks.

12. The stamp as claimed in claim 1, wherein the body further includes a marking point to make an aligning signal.

13. The stamp as claimed in claim 1, wherein the housing includes two abutting segment disposed on at least one plane thereof.

14. The stamp as claimed in claim 1, wherein the receiving room 11 includes two axial bores mounted on two side walls thereof.

15. The stamp as claimed in claim 1, wherein the stamping assembly includes a frame disposed under the stamping assembly to protect and support a sealing member.

16. The stamp as claimed in claim 15, wherein the frame includes guiding members.

17. A stamp comprising:
a body including a receiving room disposed on a lower end thereof and having a through hole on an upper end of the receiving room;
a stamping member including at least one column, each inserted to the through hole of the body, and including a stamp member having at least one guiding member;
at least one resilient element, an upper end of which abuts against the stamping assembly and a lower end thereof is biased against the body;
a housing located above the body and having at least one connecting portion coupled with the stamping assembly so as to actuate with the stamping assembly each other;
at lease one lip including two pegs disposed on two sides thereof respectively, and includes a hook mounted on at least one side thereof;
an adjusting knob being formed in a hollow frame shape and including two projections disposed on a periphery thereof to be placed between the body and the housing, a space where is placed the adjusting knob including a stopping rim to retain the projections.

18. The stamp as claimed in claim 17, wherein the lip includes an opening which allows to change its position with the adjusting knob.

19. The stamp as claimed in claim 17, wherein the housing includes an adjusting knob, and the body includes a rib having a stop rim on a lower end thereof to rotate the projections of the adjusting knob to position the stamping assembly.
